(19) United States
(12) Patent Application Publication
(10) Pub. No.: US 2023/0394344 A1
(43) Pub. Date: Dec. 7, 2023

(54) QUANTUM ENHANCED LEARNING AGENT

(71) Applicant: Zapata Computing, Inc., Boston, MA (US)

(72) Inventor: Yudong CAO, Cambridge, MA (US)

(21) Appl. No.: 18/324,832

(22) Filed: May 26, 2023

Related U.S. Application Data
(60) Provisional application No. 63/347,771, filed on Jun. 1, 2022.

(51) Int. Cl. G06N 10/20; G06N 20/00

(52) U.S. Cl. CPC G06N 10/20; G06N 20/00

(57) ABSTRACT

A method and apparatus for generating quantum-enhanced learning agents that can be used for optimizing tasks such as time series analysis, natural language processing, reinforcement learning, and combinatorial optimization. The method may be implemented on a hybrid quantum-classical computer. A learning agent is defined having an initial state S₁, a set of parameters T₁, and an input X₁. The set of parameters are updated iteratively based on the input X₁. The updated parameter set is generated, the agent state is updated, and an output is generated. Further enhancements include unrolling the agent in time and maintaining multiple copies of the agent across multiple iterations and entangling the copies of the agents. The disclosed technology may be used for computer chip design optimization for arranging chip components on a substrate, where circuit board parameters are efficiently assembled piece by piece, instead of a single optimization solution.

### CROSS-REFERENCE TO RELATED APPLICATIONS

This application claims the benefit of U.S. Prov. Pat. App. No. 63/347,771, filed on Jun. 1, 2022, entitled, “A Quantum Enhanced Learning Agent,” which is hereby incorporated by reference herein.

### BACKGROUND

The subject matter discussed in this section should not be assumed to be prior art merely as a result of its mention in this section. Similarly, any problems or shortcomings mentioned in this section or associated with the subject matter provided as background should not be assumed to have been previously recognized in the prior art. The subject matter in this section merely represents different approaches, which in and of themselves can also correspond to implementations of the claimed technology.

Quantum computing has been shown to be useful in solving many problems that are intractable with classical computers, particularly in the areas of machine learning, natural language processing, time series analysis, and combinatorial optimization.

One area of interest is reinforcement learning. Reinforcement learning (RL) is a machine learning technique that focuses on training an algorithm using a trial-and-error approach. An RL learning algorithm (agent) evaluates a current situation (state), known as the environment, and performs an action from a list of available actions for that environment. For each completed action, the agent receives feedback in the form of reward (positive feedback) or punishment (negative feedback) from the environment. Positive or negative feedback depends on whether the algorithm advances closer to, or further from, a defined solution.

In general, therefore, a reinforcement learning agent is able to perceive and interpret its environment and take actions and learn through trial and error. The reinforcement learning agent experiments in an environment, taking actions, and being rewarded when the correct actions are taken. Instead of building lengthy “if-then” instructions, the programmer prepares the reinforcement learning agent to be capable of learning from a system of rewards and penalties. The agent (the RL learning algorithms performing the task) gets rewards for reaching specific goals.

The purpose of reinforcement learning is for the agent to learn an optimal, or nearly-optimal, policy that maximizes the “reward function” or other user-provided reinforcement signals that accumulate from the immediate rewards. A basic reinforcement learning agent interacts with its environment in discrete time steps. At each time t, the agent receives the current state and reward. It then chooses an action from the set of available actions, which is subsequently sent to the environment. The environment moves to a new state and the reward associated with the transition is determined. The goal of a reinforcement learning agent is to learn a policy, which maximizes the expected cumulative reward.

One current application of reinforcement learning is chip design optimization, also known as chip floorplanning. In electronic design automation, a floorplan of an integrated circuit is a schematics representation of tentative placement of its major functional blocks. Chip components are placed and arranged on a substrate to achieve optimal placement of those components, taking into account the requirements of the netlist. These requirements may include various types of components such as processor cores, memory elements, the size of the components, the electrical power consumption, heat dissipation, run distance, signal propagation, and wiring restrictions to ensure optimal performance.

The design of current computer chips is exceedingly complex, straining the limit of classical computer technology. The present invention seeks to overcome these drawbacks using quantum computer methods.

### SUMMARY

The disclosed technology is a method and system for a quantum-enhanced learning agent. The technology may be used to solve complex problems that are difficult to solve using classical computing. The disclosed technology may be used for a variety of tasks such as time series analysis, natural language processing, reinforcement learning and combinatorial optimization. An example of a combinatorial optimization problem is the traveling salesperson problem, which is extremely difficult to solve using classical approaches.

Research suggests that quantum computers may be useful in a variety of difficult computational problems. In particular, quantum computers may be best suited to hard problems which can be specified in a relatively small number of parameters; such problems are common in material and chemical simulation, optimization, and machine learning.

According to one embodiment described herein, a method is described for using quantum computing to enhance reinforcement learning methods, particularly in the area of integrated circuit optimization or automated floorplan designing.

The basic environment in which the learning agent operates is one where the agent is provided a sequence of inputs {X₁⁽¹⁾, X₂⁽¹⁾, . . . } and the agent produces a sequence of outputs, or “actions”, {Y₁⁽¹⁾, Y₂⁽¹⁾, . . . } while updating its state {S₁⁽¹⁾, S₂⁽¹⁾, . . . }. The learning agent may, for example, generate an output Y (e.g., Y₁⁽¹⁾) based on its correspondence input X (e.g., X₁⁽¹⁾), parameters T (e.g., T₁⁽¹⁾) and state S (e.g., S₁⁽¹⁾) by applying the set of quantum gates with the set of parameters T to the state S and input X. The learning agent may at some point execute one or more new iterations, the jth iteration starting with a different sequence of inputs {X₁^{(j)}, X₂^{(j)}, . . . }, the agent producing a new set of outputs {Y₁^{(j)}, Y₂^{(j)}, . . . } and updating its state {S₁^{(j)}, S₂^{(j)}, . . . }. Such reinforcement learning agents have been used to solve combinatorial optimization problems.

The learning agent state update process may be a combination of classical and quantum information processing operations. For example, the learning agent may have an initial state S₁ and an input X₁, wherein the initial state S₁ is encoded in one or more of a plurality of qubits, and a set of quantum gates with a set of parameters T₁. The learning agent generates an output Y₁ by applying the set of quantum gates with the set of parameters T₁ to the initial state S₁ and input X₁. The learning agent computes a reward value R₁ based on the output Y₁, and updates the quantum-enhanced learning agent based on the reward value R₁. The updating may include: replacing the set of parameters T₁ with an updated set of parameters T₂; and replacing the initial state S₁ with an updated state S₂. Any state S of the learning agent may be a quantum state of a physical system maintained by the learning agent.

In another aspect, embodiments of the present invention may be used to perform iterative optimization problems such as chip design. Conventional optimizers attempt to produce an entire solution (e.g., chip design) in one step. In contrast, embodiments of the present invention may use the quantum enhanced learning agent to build an optimized solution (e.g., chip design or chip floorplan) one component at a time, which provides increased speed and efficiency.

Other features and advantages of various aspects and embodiments of the present invention will become apparent from the following description and from the claims.

### BRIEF DESCRIPTION OF THE DRAWINGS

At least one specification heading is required. Please delete this heading section if it is not applicable to your application. For more information regarding the headings of the specification, please see MPEP 608.01(a).

The disclosed technology, as well as a preferred mode of use and further objectives and advantages thereof, will best be understood by reference to the following detailed description of illustrative embodiments when read in conjunction with the accompanying drawings. In the drawings, like reference characters generally refer to like parts throughout the different views. The drawings are not necessarily to scale, with an emphasis instead generally being placed upon illustrating the principles of the technology disclosed.

FIG. 1 is a diagram of a quantum computer according to one embodiment of the present invention;

FIG. 2A is a flowchart of a method performed by the quantum computer of FIG. 1 according to one embodiment of the present invention;

FIG. 2B is a diagram of a hybrid quantum-classical computer which performs quantum annealing according to one embodiment of the present invention; and

FIG. 3 is a diagram of a hybrid quantum-classical computer according to one embodiment of the present invention.

FIG. 4 is a flowchart illustrating the method for generating a quantum-enhanced learning agent;

FIG. 5 is a schematic diagram of the information flow of one iteration of how the quantum-enhanced agent evolves while taking input X₁ and producing an output Y₁;

FIG. 6(a) illustrates a classical agent (recurrent unit), wherein the notations for input (X), state (S) and the output (Y) is the same as in FIG. 5;

FIG. 6(b) illustrates the “unrolling” of the classical agent in time;

FIG. 7 is a schematic diagram showing the enhanced agent evolution by unrolling the agent in time and entangling copies of the agent, the agent being unrolled across three iterations;

FIG. 8 illustrates an embodiment of the quantum-enhanced agent evolution described in FIG. 7;

FIG. 9 illustrates one way the quantum-enhanced agent evolution described in FIG. 8 can be realized; and

FIG. 10 illustrates the action-reward feedback loop of a generic reinforcement learning model.

### DETAILED DESCRIPTION

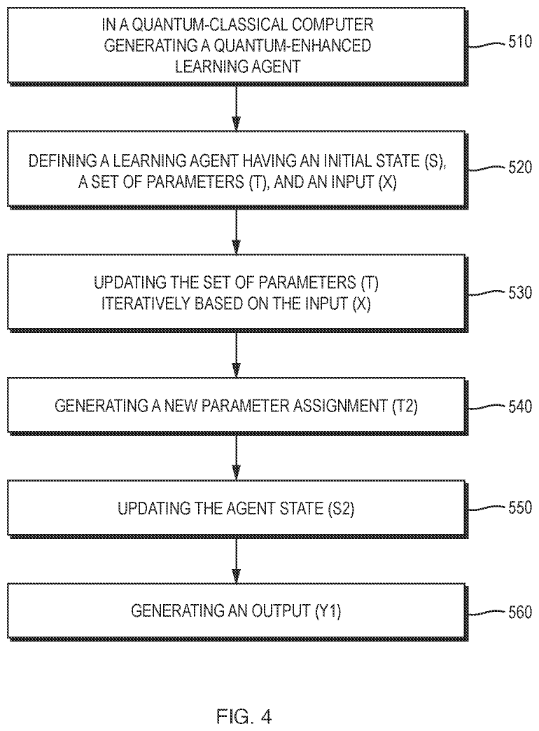

FIG. 4 is a flowchart illustrating the method for generating a quantum-enhanced learning agent. In step 510, in a quantum-classical computer, a quantum-enhanced learning agent is generated. In step 520, the learning agent is defined having an initial state (S), a set of parameters (T), and an input (X). In step 530, the set of parameters (T) is updated iteratively based on the input (X). Proceeding to step 540, a new parameter assignment (T2) is generated. In step 550, the agent state is updated. In the final step 560, an output Y1 is generated.

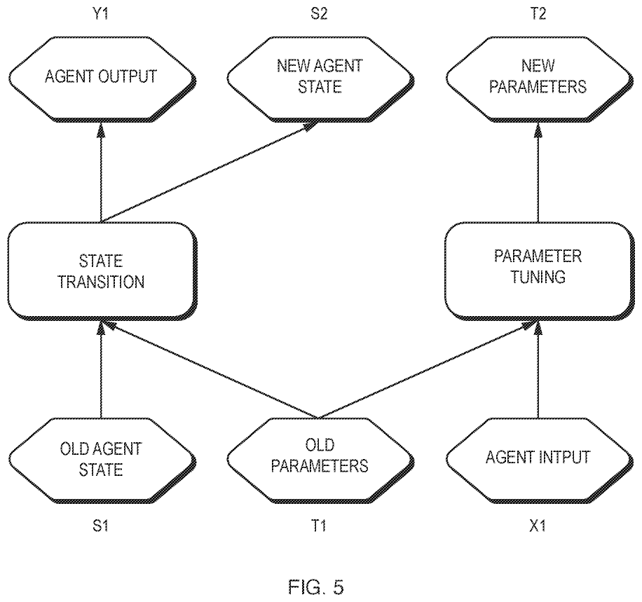

FIG. 5 is a schematic diagram of the information flow of one iteration of how the quantum-enhanced agent evolves while taking input X1 and producing an output Y1, which is described in connection with FIG. 4.

Features of the disclosed technology include an agent transition process that is a combination of classical and quantum information processing operations. During each iteration, the agent starts with an initial state S₁⁽¹⁾, a set of parameters T₁⁽¹⁾, and input X₁⁽¹⁾. The parameters of the agent are then updated based on the input X₁⁽¹⁾, generating a new parameter assignment T₂⁽¹⁾. The state of the agent is at the same time updated to be S₂⁽¹⁾ while generating an output Y₁⁽¹⁾. The quantum mechanical nature of the agent is manifested in that the state Sᵢ^{(j)} can be a quantum state of a physical system that is maintained by the agent. That is, an agent state Sᵢ^{(j)} may be a quantum state of physical system that is entangled with an output Yₖ^{(j)} or another state Sₖ^{(j)} for some i≠k. Similarly, the output Yᵢ^{(j)} may be entangled with Sₗ^{(j)} or another output Yₖ^{(j)} for some i≠k. Note that the sets of parameters Tᵢ^{(j)} are used to generate the ith quantum circuit of the jth iteration.

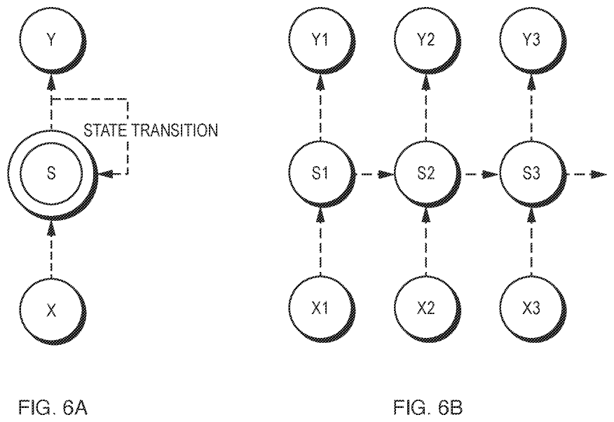

FIG. 6(a) illustrates a classical agent (recurrent unit), wherein the notations for input (X), state (S) and the output (Y) is the same as in FIG. 5. Quantum enhancement of the statistical correlation that the learning agent can realize comes from “unrolling” the agent in time in a way that is shown in FIG. 6(b), namely keeping multiple copies of the agent with each copy corresponding to an iteration of the agent.

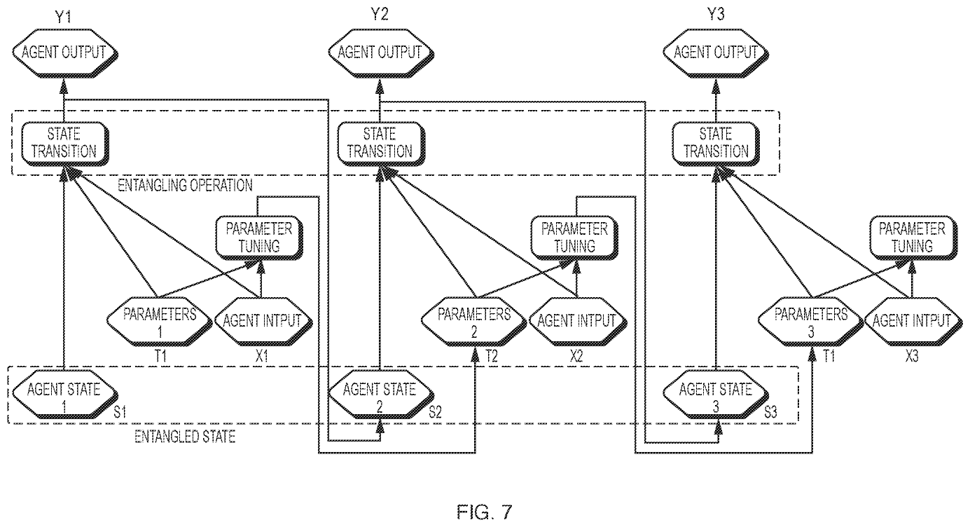

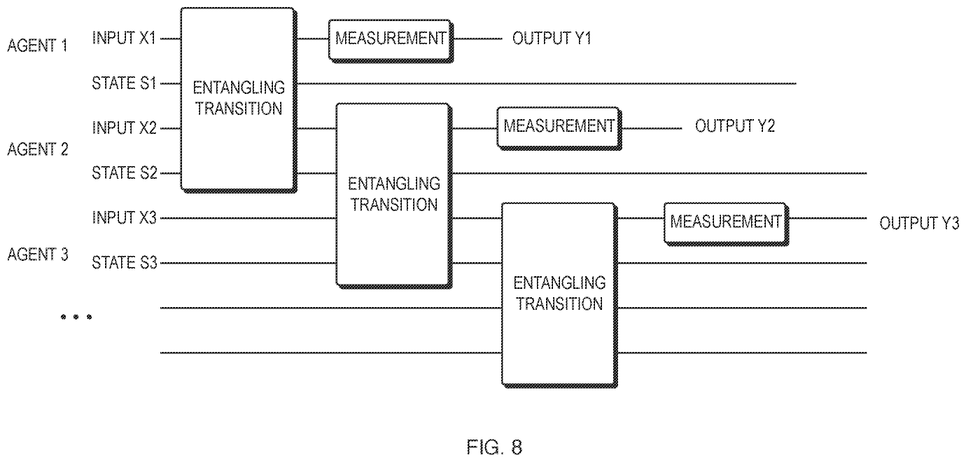

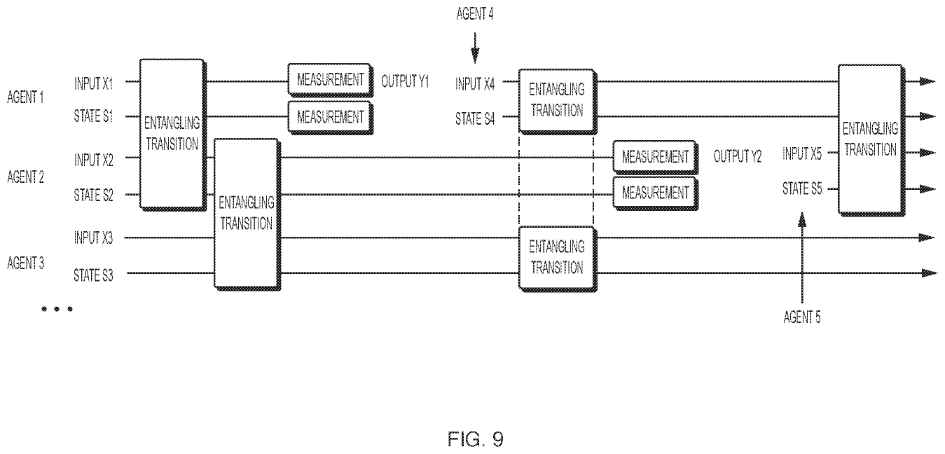

As shown in FIG. 7, unrolling the quantum learning agent offers an opportunity to generate quantum correlations by entangling the states of the multiple copies of the agent. Such quantum correlations likely require large classical overhead to replicate. In the scheme described in FIG. 6 and exemplified in FIG. 7, for n iterations unrolled, even for restricted quantum states such as n-qubit stabilizer states it takes O(n²) memory to describe the joint n-system state, making them difficult to simulate with classical computers. FIG. 8 and FIG. 9 provide an example of how this unrolling may be realized with quantum circuits.

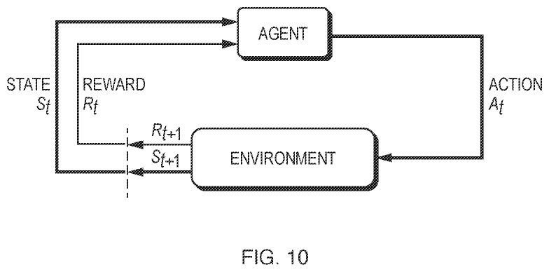

Turning to FIG. 10, a generic reinforcement learning (RL) model is shown, illustrating the action reward feedback loop. The RL agent receives positive or negative feedback once a task is completed. Therefore, this is the difference between time-delayed feedback and the trial-and-error principle, which differentiates reinforcement learning from supervised learning. Since one of the goals of reinforcement learning RL is to find a set of consecutive actions that maximize a reward, sequential decision making is another significant difference between these algorithm training styles. Each agent's decision can affect its future actions.

Embodiments of the disclosed invention may utilize quantum learning agents for optimization. The goal of optimization is to construct a solution that optimizes an objective function. The objective function, depending on the optimization problem to be solved, may be evaluated either at each step (i.e., through measurement of some of the output bits), or only at the end of each iteration. A candidate solution for the optimization may have many components. For instance, in a traveling salesperson problem, a traversing path is a candidate solution which has many edges as its components. A learning agent may produce a sequence of outputs {Y₁^{(j)}, Y₂^{(j)}, . . . } with each Yᵢ^{(j)} being a destination node on the graph. In other words, the learning agent builds the solution one component at a time, instead of producing an entire solution in one step like many optimizers.

Embodiments of the disclosed invention may be utilized for time series analysis and forecasting where the learning agent may produce a sequence of outputs with each Yₜ^{(j)} being a data point associated with a particular time t. Embodiments of the disclosed invention may be utilized for reinforcement learning where the learning agent may produce a sequence of outputs with each Yᵢ^{(j)} associated with an action of the agent. Embodiments of the disclosed invention may be utilized for natural language processing where the learning agent receives a series of inputs Xᵢ^{(j)} based on words and produces a sequence of outputs with each Yᵢ^{(j)} associated with an embedding.

The goal of optimization is to construct a solution that optimizes an objective function. The solution may have many components. For instance, in a traveling salesperson problem, a traversing path is a candidate solution which has many edges as its components. A learning agent may produce a sequence of outputs Y1, Y2, . . . with each Y being a destination node on the graph

The disclosed technology may be used with additional applications. In each case above, the quantum enhanced agent receives a sequence of inputs, changes its state (which can be used as a classifier label) and, optionally, the output sequence may be used.

For time series, the agent receives a sequence of data. In this case, it may not necessarily produce a sequence of useful output data, but its final state S can be used as a classifier. For example, “0” may represent “no anomaly” and “1” may represent “anomaly.”

For Natural Language Processing (NLP), the classification method may be performed. For example, sentiment analysis may be performed on the state of the agent (e.g., 0=happy and 1=not happy). Also, sequence-to-sequence translation may be performed with the outputs.

For reinforcement learning, the sequence of output actions may be used as described above. One current application of reinforcement learning is chip design optimization, also known as chip floorplanning. In electronic design automation, a floorplan of an integrated circuit is a schematics representation of tentative placement of its major functional blocks. Chip components are placed and arranged on a substrate to achieve optimal placement of those components, taking into account the requirements of the netlist. These requirements may include various types of components such as processor cores, memory elements, the size of the components, the electrical power consumption, heat dissipation, run distance, signal propagation, and wiring restrictions to ensure optimal performance. The design of current computer chips is exceedingly complex, straining the limit of classical computer technology. The present invention may be used to overcome these drawbacks using quantum computer systems and methods.

The above-described methods may be practiced using a hybrid quantum classical computer.

In some embodiments, the techniques described herein relate to a method, performed on a hybrid quantum-classical computer system, for training a quantum-enhanced learning agent, the hybrid quantum-classical computer system including a classical computer and a quantum computer, the classical computer including a processor, a non-transitory computer readable medium, and computer instructions stored in the non-transitory computer readable medium; the quantum computer including a quantum component having a plurality of qubits encoded in quantum states of a physical system; the quantum-enhanced learning agent having an initial state S1, an input X1, and a set of quantum gates with a set of parameters T1, wherein the initial state S1 is encoded in one or more of the plurality of qubits; wherein the computer instructions, when executed by the processor, perform the method, the method including: generating an output Y1 by applying the set of quantum gates with the set of parameters T1 to the initial state S1 and input X1, computing a reward value R1 based on the output Y1; updating the quantum-enhanced learning agent based on the reward value R1, the updating including: replacing the set of parameters T1 with an updated set of parameters T2 and replacing the initial state S1 with an updated state S2.

Updating the quantum-enhanced learning agent may include updating the quantum-enhanced learning agent a plurality of times, the k^{th} update having input Xₖ, an updated state Sₖ, an updated set of parameters Tₖ, and output Yₖ.

An agent state Sᵢ may be entangled with an output Yₖ output of another state Sₖ for some i≠k.

An output Yᵢ may be entangled with Sᵢ or another output Yₖ for some i≠k.

The method may further include unrolling the quantum-enhanced learning agent in time, wherein a plurality of copies of the quantum-enhanced learning agent are simultaneously maintained, with each copy corresponding to an update of the quantum-enhanced learning agent.

The method may further include generating quantum correlations by entangling states of the multiple copies of the quantum-enhanced learning agent. For n iterations unrolled, the method may be applied to restricted quantum states, such as n-qubit stabilizer states. The unrolling may be accomplished with quantum circuits.

The method may further include using the quantum-enhanced learning agent to solve an optimization problem by constructing a solution that optimizes an objective function having discrete steps. Solving the optimization problem may include evaluating each step leading to a solution by measuring designated output bits. The solution may be evaluated at the end of each iteration. Using the quantum-enhanced learning agent to solve the optimization problem may include using the quantum-enhanced learning agent to produce a sequence of outputs as a destination node on a graph, including building the solution one component at a time. The optimization problem may include an optimization problem for optimum placement of chip components on a substrate. Using the quantum-enhanced learning agent to solve the optimization problem may include using the quantum-enhanced learning agent to build a chip placement optimization solution one step at a time.

The method may further include using the quantum-enhanced learning agent to solve a combinatorial optimization problem.

The method may further included using the quantum-enhanced learning agent for timeseries analysis and forecasting.

The method may further include using the quantum-enhanced learning agent for reinforcement learning, wherein the quantum-enhanced learning agent produces a sequence of outputs for each output Y associated with the action of the quantum-enhanced learning agent.

The method may further include using the quantum-enhanced learning agent for natural language processing NLP, wherein the quantum-enhanced learning agent receives a series of inputs based on words and produces a sequence of outputs, wherein each output is associated with an embedding.

The method may further include using the quantum-enhanced learning agent to solve a traveling salesperson problem.

In some embodiments, the techniques described herein relate to a hybrid quantum-classical computer system for training a quantum-enhanced learning agent, the hybrid quantum-classical computer system including: a classical computer including a processor, a non-transitory computer readable medium, and computer instructions stored in the non-transitory computer readable medium; a quantum computer including a quantum component having a plurality of qubits encoded in quantum states of a physical system; the quantum-enhanced learning agent having an initial state S1, an input X1, and a set of quantum gates with a set of parameters T1, wherein the initial state S1 is encoded in one or more of the plurality of qubits; wherein the computer program instructions, when executed by the processor, are adapted to cause the processor to perform a method, the method including: generating an output Y1 by applying the set of quantum gates with the set of parameters T1 to the initial state S1 and input X1, computing a reward value R1 based on the output Y1; updating the quantum-enhanced learning agent based on the reward value R1, the updating including: replacing the set of parameters T1 with an updated set of parameters T2 and replacing the initial state S1 with an updated state S2.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Various physical embodiments of a quantum computer are suitable for use according to the present disclosure. In general, the fundamental data storage unit in quantum computing is the quantum bit, or qubit. The qubit is a quantum-computing analog of a classical digital computer system bit. A classical bit is considered to occupy, at any given point in time, one of two possible states corresponding to the binary digits (bits) 0 or 1. By contrast, a qubit is implemented in hardware by a physical medium with quantum-mechanical characteristics. Such a medium, which physically instantiates a qubit, may be referred to herein as a “physical instantiation of a qubit,” a “physical embodiment of a qubit,” a “medium embodying a qubit,” or similar terms, or simply as a “qubit,” for ease of explanation. It should be understood, therefore, that references herein to “qubits” within descriptions of embodiments of the present invention refer to physical media which embody qubits.

Each qubit has an infinite number of different potential quantum-mechanical states. When the state of a qubit is physically measured, the measurement produces one of two different basis states resolved from the state of the qubit. Thus, a single qubit can represent a one, a zero, or any quantum superposition of those two qubit states; a pair of qubits can be in any quantum superposition of 4 orthogonal basis states; and three qubits can be in any superposition of 8 orthogonal basis states. The function that defines the quantum-mechanical states of a qubit is known as its wavefunction. The wavefunction also specifies the probability distribution of outcomes for a given measurement. A qubit, which has a quantum state of dimension two (i.e., has two orthogonal basis states), may be generalized to a d-dimensional “qudit,” where d may be any integral value, such as 2, 3, 4, or higher. In the general case of a qudit, measurement of the qudit produces one of d different basis states resolved from the state of the qudit. Any reference herein to a qubit should be understood to refer more generally to an d-dimensional qudit with any value of d.

Although certain descriptions of qubits herein may describe such qubits in terms of their mathematical properties, each such qubit may be implemented in a physical medium in any of a variety of different ways. Examples of such physical media include superconducting material, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or aggregations of any of the foregoing that exhibit qubit behavior, that is, comprising quantum states and transitions therebetween that can be controllably induced or detected.

For any given medium that implements a qubit, any of a variety of properties of that medium may be chosen to implement the qubit. For example, if electrons are chosen to implement qubits, then the x component of its spin degree of freedom may be chosen as the property of such electrons to represent the states of such qubits. Alternatively, the y component, or the z component of the spin degree of freedom may be chosen as the property of such electrons to represent the state of such qubits. This is merely a specific example of the general feature that for any physical medium that is chosen to implement qubits, there may be multiple physical degrees of freedom (e.g., the x, y, and z components in the electron spin example) that may be chosen to represent 0 and 1. For any particular degree of freedom, the physical medium may controllably be put in a state of superposition, and measurements may then be taken in the chosen degree of freedom to obtain readouts of qubit values.

Certain implementations of quantum computers, referred to as gate model quantum computers, comprise quantum gates. In contrast to classical gates, there is an infinite number of possible single-qubit quantum gates that change the state vector of a qubit. Changing the state of a qubit state vector typically is referred to as a single-qubit rotation, and may also be referred to herein as a state change or a single-qubit quantum-gate operation. A rotation, state change, or single-qubit quantum-gate operation may be represented mathematically by a unitary 2×2 matrix with complex elements. A rotation corresponds to a rotation of a qubit state within its Hilbert space, which may be conceptualized as a rotation of the Bloch sphere. (As is well-known to those having ordinary skill in the art, the Bloch sphere is a geometrical representation of the space of pure states of a qubit.) Multi-qubit gates alter the quantum state of a set of qubits. For example, two-qubit gates rotate the state of two qubits as a rotation in the four-dimensional Hilbert space of the two qubits. (As is well-known to those having ordinary skill in the art, a Hilbert space is an abstract vector space possessing the structure of an inner product that allows length and angle to be measured. Furthermore, Hilbert spaces are complete: there are enough limits in the space to allow the techniques of calculus to be used.)

A quantum circuit may be specified as a sequence of quantum gates. As described in more detail below, the term “quantum gate,” as used herein, refers to the application of a gate control signal (defined below) to one or more qubits to cause those qubits to undergo certain physical transformations and thereby to implement a logical gate operation. To conceptualize a quantum circuit, the matrices corresponding to the component quantum gates may be multiplied together in the order specified by the gate sequence to produce a 2n×2n complex matrix representing the same overall state change on n qubits. A quantum circuit may thus be expressed as a single resultant operator. However, designing a quantum circuit in terms of constituent gates allows the design to conform to a standard set of gates, and thus enable greater ease of deployment. A quantum circuit thus corresponds to a design for actions taken upon the physical components of a quantum computer.

A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In certain embodiments of quantum circuits, the quantum circuit includes both one or more gates and one or more measurement operations. Quantum computers implemented using such quantum circuits are referred to herein as implementing “measurement feedback.” For example, a quantum computer implementing measurement feedback may execute the gates in a quantum circuit and then measure only a subset (i.e., fewer than all) of the qubits in the quantum computer, and then decide which gate(s) to execute next based on the outcome(s) of the measurement(s). In particular, the measurement(s) may indicate a degree of error in the gate operation(s), and the quantum computer may decide which gate(s) to execute next based on the degree of error. The quantum computer may then execute the gate(s) indicated by the decision. This process of executing gates, measuring a subset of the qubits, and then deciding which gate(s) to execute next may be repeated any number of times. Measurement feedback may be useful for performing quantum error correction, but is not limited to use in performing quantum error correction. For every quantum circuit, there is an error-corrected implementation of the circuit with or without measurement feedback.

Some embodiments described herein generate, measure, or utilize quantum states that approximate a target quantum state (e.g., a ground state of a Hamiltonian). As will be appreciated by those trained in the art, there are many ways to quantify how well a first quantum state “approximates” a second quantum state. In the following description, any concept or definition of approximation known in the art may be used without departing from the scope hereof. For example, when the first and second quantum states are represented as first and second vectors, respectively, the first quantum state approximates the second quantum state when an inner product between the first and second vectors (called the “fidelity” between the two quantum states) is greater than a predefined amount (typically labeled E). In this example, the fidelity quantifies how “close” or “similar” the first and second quantum states are to each other. The fidelity represents a probability that a measurement of the first quantum state will give the same result as if the measurement were performed on the second quantum state. Proximity between quantum states can also be quantified with a distance measure, such as a Euclidean norm, a Hamming distance, or another type of norm known in the art. Proximity between quantum states can also be defined in computational terms. For example, the first quantum state approximates the second quantum state when a polynomial time-sampling of the first quantum state gives some desired information or property that it shares with the second quantum state.

Not all quantum computers are gate model quantum computers. Embodiments of the present invention are not limited to being implemented using gate model quantum computers. As an alternative example, embodiments of the present invention may be implemented, in whole or in part, using a quantum computer that is implemented using a quantum annealing architecture, which is an alternative to the gate model quantum computing architecture. More specifically, quantum annealing (QA) is a metaheuristic for finding the global minimum of a given objective function over a given set of candidate solutions (candidate states), by a process using quantum fluctuations.

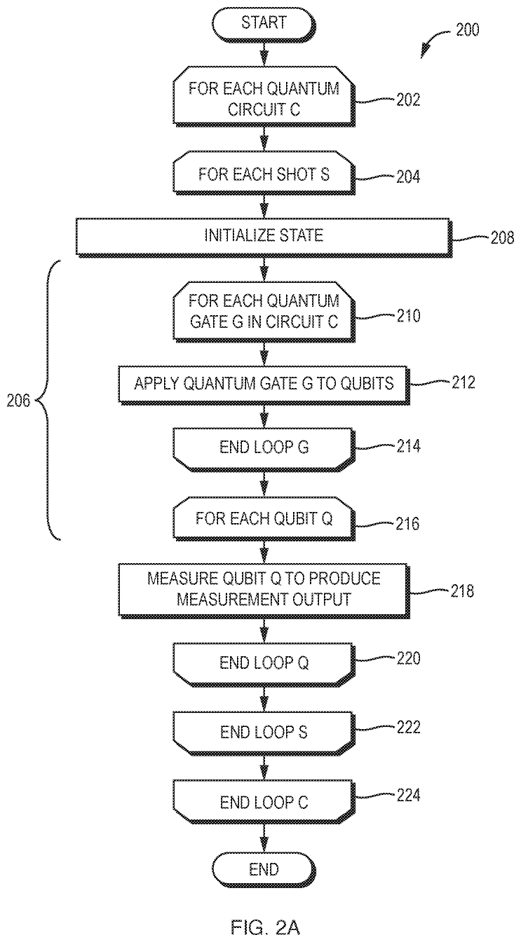

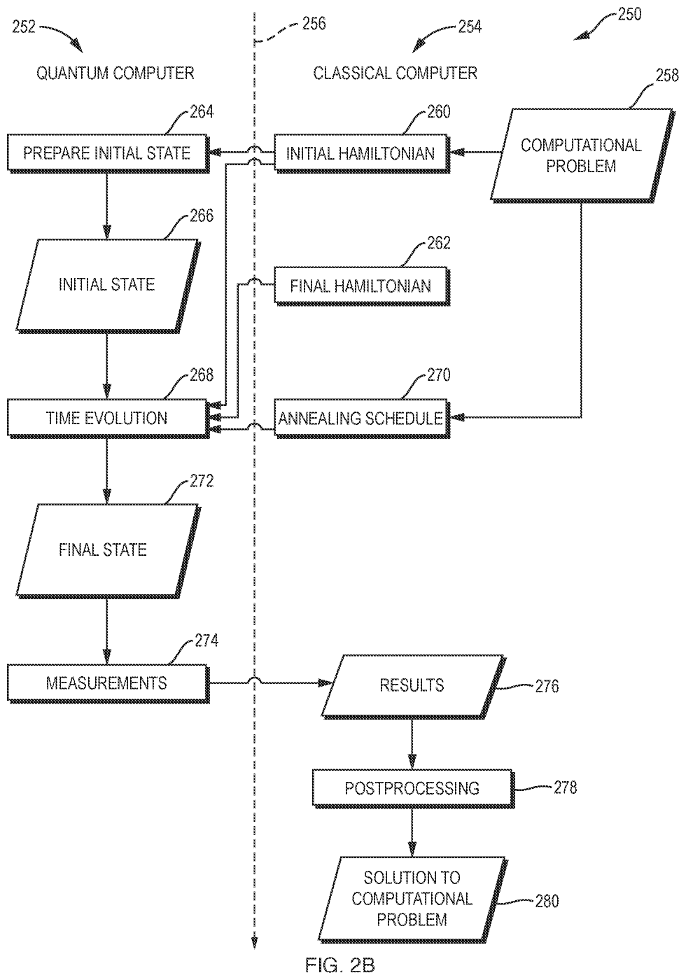

FIG. 2B shows a diagram illustrating operations typically performed by a computer system 250 which implements quantum annealing. The system 250 includes both a quantum computer 252 and a classical computer 254. Operations shown on the left of the dashed vertical line 256 typically are performed by the quantum computer 252, while operations shown on the right of the dashed vertical line 256 typically are performed by the classical computer 254.

Quantum annealing starts with the classical computer 254 generating an initial Hamiltonian 260 and a final Hamiltonian 262 based on a computational problem 258 to be solved, and providing the initial Hamiltonian 260, the final Hamiltonian 262 and an annealing schedule 270 as input to the quantum computer 252. The quantum computer 252 prepares a well-known initial state 266 (FIG. 2B, operation 264), such as a quantum-mechanical superposition of all possible states (candidate states) with equal weights, based on the initial Hamiltonian 260. The classical computer 254 provides the initial Hamiltonian 260, a final Hamiltonian 262, and an annealing schedule 270 to the quantum computer 252. The quantum computer 252 starts in the initial state 266, and evolves its state according to the annealing schedule 270 following the time-dependent Schrödinger equation, a natural quantum-mechanical evolution of physical systems (FIG. 2B, operation 268). More specifically, the state of the quantum computer 252 undergoes time evolution under a time-dependent Hamiltonian, which starts from the initial Hamiltonian 260 and terminates at the final Hamiltonian 262. If the rate of change of the system Hamiltonian is slow enough, the system stays close to the ground state of the instantaneous Hamiltonian. If the rate of change of the system Hamiltonian is accelerated, the system may leave the ground state temporarily but produce a higher likelihood of concluding in the ground state of the final problem Hamiltonian, i.e., diabatic quantum computation. At the end of the time evolution, the set of qubits on the quantum annealer is in a final state 272, which is expected to be close to the ground state of the classical Ising model that corresponds to the solution to the original optimization problem 258. An experimental demonstration of the success of quantum annealing for random magnets was reported immediately after the initial theoretical proposal.

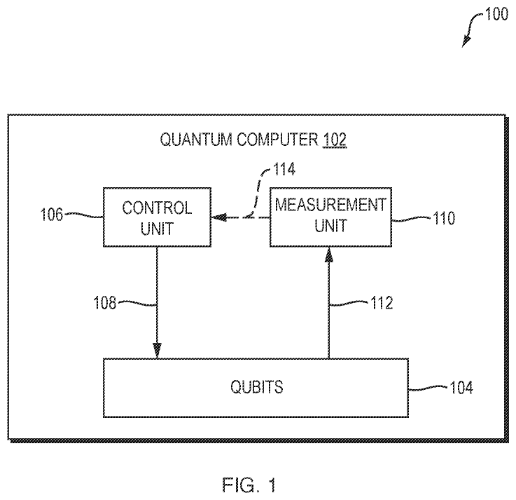

The final state 272 of the quantum computer 252 is measured, thereby producing results 276 (i.e., measurements) (FIG. 2B, operation 274). The measurement operation 274 may be performed, for example, in any of the ways disclosed herein, such as in any of the ways disclosed herein in connection with the measurement unit 110 in FIG. 1. The classical computer 254 performs postprocessing on the measurement results 276 to produce output 280 representing a solution to the original computational problem 258 (FIG. 2B, operation 278).

As yet another alternative example, embodiments of the present invention may be implemented, in whole or in part, using a quantum computer that is implemented using a one-way quantum computing architecture, also referred to as a measurement-based quantum computing architecture, which is another alternative to the gate model quantum computing architecture. More specifically, the one-way or measurement based quantum computer (MBQC) is a method of quantum computing that first prepares an entangled resource state, usually a cluster state or graph state, then performs single qubit measurements on it. It is “one-way” because the resource state is destroyed by the measurements.

The outcome of each individual measurement is random, but they are related in such a way that the computation always succeeds. In general the choices of basis for later measurements need to depend on the results of earlier measurements, and hence the measurements cannot all be performed at the same time.

Any of the functions disclosed herein may be implemented using means for performing those functions. Such means include, but are not limited to, any of the components disclosed herein, such as the computer-related components described below.

Referring to FIG. 1, a diagram is shown of a system 100 implemented according to one embodiment of the present invention. Referring to FIG. 2A, a flowchart is shown of a method 200 performed by the system 100 of FIG. 1 according to one embodiment of the present invention. The system 100 includes a quantum computer 102. The quantum computer 102 includes a plurality of qubits 104, which may be implemented in any of the ways disclosed herein. There may be any number of qubits 104 in the quantum computer 102. For example, the qubits 104 may include or consist of no more than 2 qubits, no more than 4 qubits, no more than 8 qubits, no more than 16 qubits, no more than 32 qubits, no more than 64 qubits, no more than 128 qubits, no more than 256 qubits, no more than 512 qubits, no more than 1024 qubits, no more than 2048 qubits, no more than 4096 qubits, or no more than 8192 qubits. These are merely examples, in practice there may be any number of qubits 104 in the quantum computer 102.

There may be any number of gates in a quantum circuit. However, in some embodiments the number of gates may be at least proportional to the number of qubits 104 in the quantum computer 102. In some embodiments the gate depth may be no greater than the number of qubits 104 in the quantum computer 102, or no greater than some linear multiple of the number of qubits 104 in the quantum computer 102 (e.g., 2, 3, 4, 5, 6, or 7).

The qubits 104 may be interconnected in any graph pattern. For example, they be connected in a linear chain, a two-dimensional grid, an all-to-all connection, any combination thereof, or any subgraph of any of the preceding.

As will become clear from the description below, although element 102 is referred to herein as a “quantum computer,” this does not imply that all components of the quantum computer 102 leverage quantum phenomena. One or more components of the quantum computer 102 may, for example, be classical (i.e., non-quantum components) components which do not leverage quantum phenomena.

The quantum computer 102 includes a control unit 106, which may include any of a variety of circuitry and/or other machinery for performing the functions disclosed herein. The control unit 106 may, for example, consist entirely of classical components. The control unit 106 generates and provides as output one or more control signals 108 to the qubits 104. The control signals 108 may take any of a variety of forms, such as any kind of electromagnetic signals, such as electrical signals, magnetic signals, optical signals (e.g., laser pulses), or any combination thereof.

For example:
In embodiments in which some or all of the qubits 104 are implemented as photons (also referred to as a “quantum optical” implementation) that travel along waveguides, the control unit 106 may be a beam splitter (e.g., a heater or a mirror), the control signals 108 may be signals that control the heater or the rotation of the mirror, the measurement unit 110 may be a photodetector, and the measurement signals 112 may be photons.
In embodiments in which some or all of the qubits 104 are implemented as charge type qubits (e.g., transmon, X-mon, G-mon) or flux-type qubits (e.g., flux qubits, capacitively shunted flux qubits) (also referred to as a “circuit quantum electrodynamic” (circuit QED) implementation), the control unit 106 may be a bus resonator activated by a drive, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as superconducting circuits, the control unit 106 may be a circuit QED-assisted control unit or a direct capacitive coupling control unit or an inductive capacitive coupling control unit, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as trapped ions (e.g., electronic states of, e.g., magnesium ions), the control unit 106 may be a laser, the control signals 108 may be laser pulses, the measurement unit 110 may be a laser and either a CCD or a photodetector (e.g., a photomultiplier tube), and the measurement signals 112 may be photons.
In embodiments in which some or all of the qubits 104 are implemented using nuclear magnetic resonance (NMR) (in which case the qubits may be molecules, e.g., in liquid or solid form), the control unit 106 may be a radio frequency (RF) antenna, the control signals 108 may be RF fields emitted by the RF antenna, the measurement unit 110 may be another RF antenna, and the measurement signals 112 may be RF fields measured by the second RF antenna.
In embodiments in which some or all of the qubits 104 are implemented as nitrogen-vacancy centers (NV centers), the control unit 106 may, for example, be a laser, a microwave antenna, or a coil, the control signals 108 may be visible light, a microwave signal, or a constant electromagnetic field, the measurement unit 110 may be a photodetector, and the measurement signals 112 may be photons.
In embodiments in which some or all of the qubits 104 are implemented as two-dimensional quasiparticles called “anyons” (also referred to as a “topological quantum computer” implementation), the control unit 106 may be nanowires, the control signals 108 may be local electrical fields or microwave pulses, the measurement unit 110 may be superconducting circuits, and the measurement signals 112 may be voltages.
In embodiments in which some or all of the qubits 104 are implemented as semiconducting material (e.g., nanowires), the control unit 106 may be microfabricated gates, the control signals 108 may be RF or microwave signals, the measurement unit 110 may be microfabricated gates, and the measurement signals 112 may be RF or microwave signals.

Although not shown explicitly in FIG. 1 and not required, the measurement unit 110 may provide one or more feedback signals 114 to the control unit 106 based on the measurement signals 112. For example, quantum computers referred to as “one-way quantum computers” or “measurement-based quantum computers” utilize such feedback 114 from the measurement unit 110 to the control unit 106. Such feedback 114 is also necessary for the operation of fault-tolerant quantum computing and error correction.

The control signals 108 may, for example, include one or more state preparation signals which, when received by the qubits 104, cause some or all of the qubits 104 to change their states. Such state preparation signals constitute a quantum circuit also referred to as an “ansatz circuit.” The resulting state of the qubits 104 is referred to herein as an “initial state” or an “ansatz state.” The process of outputting the state preparation signal(s) to cause the qubits 104 to be in their initial state is referred to herein as “state preparation” (FIG. 2A, section 206). A special case of state preparation is “initialization,” also referred to as a “reset operation,” in which the initial state is one in which some or all of the qubits 104 are in the “zero” state i.e. the default single-qubit state. More generally, state preparation may involve using the state preparation signals to cause some or all of the qubits 104 to be in any distribution of desired states. In some embodiments, the control unit 106 may first perform initialization on the qubits 104 and then perform preparation on the qubits 104, by first outputting a first set of state preparation signals to initialize the qubits 104, and by then outputting a second set of state preparation signals to put the qubits 104 partially or entirely into non-zero states.

Another example of control signals 108 that may be output by the control unit 106 and received by the qubits 104 are gate control signals. The control unit 106 may output such gate control signals, thereby applying one or more gates to the qubits 104. Applying a gate to one or more qubits causes the set of qubits to undergo a physical state change which embodies a corresponding logical gate operation (e.g., single-qubit rotation, two-qubit entangling gate or multi-qubit operation) specified by the received gate control signal. As this implies, in response to receiving the gate control signals, the qubits 104 undergo physical transformations which cause the qubits 104 to change state in such a way that the states of the qubits 104, when measured (see below), represent the results of performing logical gate operations specified by the gate control signals. The term “quantum gate,” as used herein, refers to the application of a gate control signal to one or more qubits to cause those qubits to undergo the physical transformations described above and thereby to implement a logical gate operation.

It should be understood that the dividing line between state preparation (and the corresponding state preparation signals) and the application of gates (and the corresponding gate control signals) may be chosen arbitrarily. For example, some or all the components and operations that are illustrated in FIGS. 1 and 2A-2B as elements of “state preparation” may instead be characterized as elements of gate application. Conversely, for example, some or all of the components and operations that are illustrated in FIGS. 1 and 2A-2B as elements of “gate application” may instead be characterized as elements of state preparation. As one particular example, the system and method of FIGS. 1 and 2A-2B may be characterized as solely performing state preparation followed by measurement, without any gate application, where the elements that are described herein as being part of gate application are instead considered to be part of state preparation. Conversely, for example, the system and method of FIGS. 1 and 2A-2B may be characterized as solely performing gate application followed by measurement, without any state preparation, and where the elements that are described herein as being part of state preparation are instead considered to be part of gate application.

The quantum computer 102 also includes a measurement unit 110, which performs one or more measurement operations on the qubits 104 to read out measurement signals 112 (also referred to herein as “measurement results”) from the qubits 104, where the measurement results 112 are signals representing the states of some or all of the qubits 104. In practice, the control unit 106 and the measurement unit 110 may be entirely distinct from each other, or contain some components in common with each other, or be implemented using a single unit (i.e., a single unit may implement both the control unit 106 and the measurement unit 110). For example, a laser unit may be used both to generate the control signals 108 and to provide stimulus (e.g., one or more laser beams) to the qubits 104 to cause the measurement signals 112 to be generated.

In general, the quantum computer 102 may perform various operations described above any number of times. For example, the control unit 106 may generate one or more control signals 108, thereby causing the qubits 104 to perform one or more quantum gate operations. The measurement unit 110 may then perform one or more measurement operations on the qubits 104 to read out a set of one or more measurement signals 112. The measurement unit 110 may repeat such measurement operations on the qubits 104 before the control unit 106 generates additional control signals 108, thereby causing the measurement unit 110 to read out additional measurement signals 112 resulting from the same gate operations that were performed before reading out the previous measurement signals 112. The measurement unit 110 may repeat this process any number of times to generate any number of measurement signals 112 corresponding to the same gate operations. The quantum computer 102 may then aggregate such multiple measurements of the same gate operations in any of a variety of ways.

After the measurement unit 110 has performed one or more measurement operations on the qubits 104 after they have performed one set of gate operations, the control unit 106 may generate one or more additional control signals 108, which may differ from the previous control signals 108, thereby causing the qubits 104 to perform one or more additional quantum gate operations, which may differ from the previous set of quantum gate operations. The process described above may then be repeated, with the measurement unit 110 performing one or more measurement operations on the qubits 104 in their new states (resulting from the most recently-performed gate operations).

In general, the system 100 may implement a plurality of quantum circuits as follows. For each quantum circuit C in the plurality of quantum circuits (FIG. 2A, operation 202), the system 100 performs a plurality of “shots” on the qubits 104. The meaning of a shot will become clear from the description that follows. For each shot S in the plurality of shots (FIG. 2A, operation 204), the system 100 prepares the state of the qubits 104 (FIG. 2A, section 206). More specifically, for each quantum gate G in quantum circuit C (FIG. 2A, operation 210), the system 100 applies quantum gate G to the qubits 104 (FIG. 2A, operations 212 and 214).

Then, for each of the qubits Q 104 (FIG. 2A, operation 216), the system 100 measures the qubit Q to produce measurement output representing a current state of qubit Q (FIG. 2A, operations 218 and 220).

The operations described above are repeated for each shot S (FIG. 2A, operation 222), and circuit C (FIG. 2A, operation 224). As the description above implies, a single “shot” involves preparing the state of the qubits 104 and applying all of the quantum gates in a circuit to the qubits 104 and then measuring the states of the qubits 104; and the system 100 may perform multiple shots for one or more circuits.

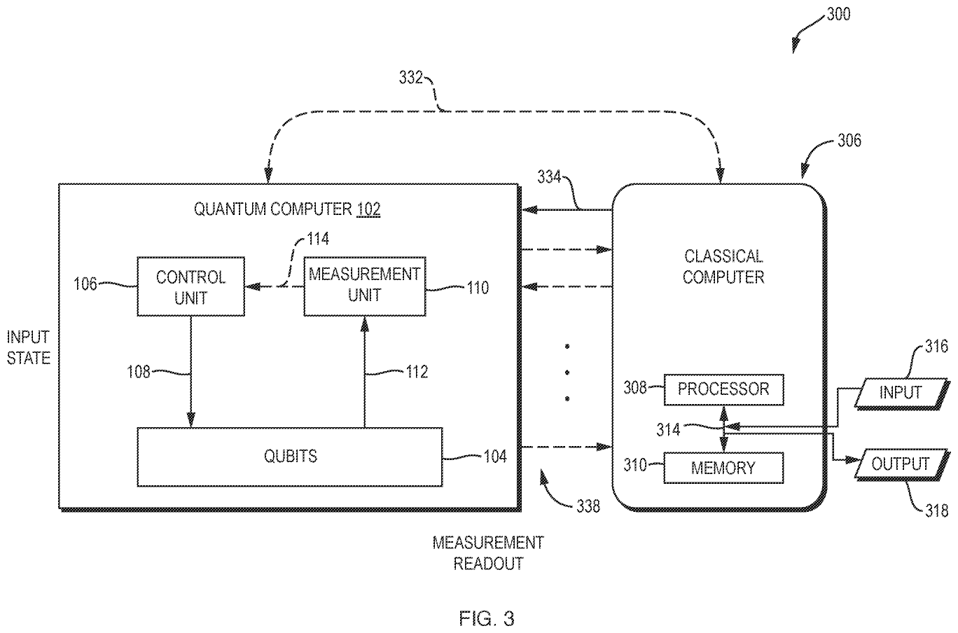

Referring to FIG. 3, a diagram is shown of a hybrid quantum classical computer (HQC) 300 implemented according to one embodiment of the present invention. The HQC 300 includes a quantum computer component 102 (which may, for example, be implemented in the manner shown and described in connection with FIG. 1) and a classical computer component 306. The classical computer component may be a machine implemented according to the general computing model established by John Von Neumann, in which programs are written in the form of ordered lists of instructions and stored within a classical (e.g., digital) memory 310 and executed by a classical (e.g., digital) processor 308 of the classical computer. The memory 310 is classical in the sense that it stores data in a storage medium in the form of bits, which have a single definite binary state at any point in time. The bits stored in the memory 310 may, for example, represent a computer program. The classical computer component 304 typically includes a bus 314. The processor 308 may read bits from and write bits to the memory 310 over the bus 314. For example, the processor 308 may read instructions from the computer program in the memory 310, and may optionally receive input data 316 from a source external to the computer 302, such as from a user input device such as a mouse, keyboard, or any other input device. The processor 308 may use instructions that have been read from the memory 310 to perform computations on data read from the memory 310 and/or the input 316, and generate output from those instructions. The processor 308 may store that output back into the memory 310 and/or provide the output externally as output data 318 via an output device, such as a monitor, speaker, or network device.

The quantum computer component 102 may include a plurality of qubits 104, as described above in connection with FIG. 1. A single qubit may represent a one, a zero, or any quantum superposition of those two qubit states. The classical computer component 304 may provide classical state preparation signals 332 to the quantum computer 102, in response to which the quantum computer 102 may prepare the states of the qubits 104 in any of the ways disclosed herein, such as in any of the ways disclosed in connection with FIGS. 1 and 2A-2B.

Once the qubits 104 have been prepared, the classical processor 308 may provide classical control signals 334 to the quantum computer 102, in response to which the quantum computer 102 may apply the gate operations specified by the control signals 332 to the qubits 104, as a result of which the qubits 104 arrive at a final state. The measurement unit 110 in the quantum computer 102 (which may be implemented as described above in connection with FIGS. 1 and 2A-2B) may measure the states of the qubits 104 and produce measurement output 338 representing the collapse of the states of the qubits 104 into one of their eigenstates. As a result, the measurement output 338 includes or consists of bits and therefore represents a classical state. The quantum computer 102 provides the measurement output 338 to the classical processor 308. The classical processor 308 may store data representing the measurement output 338 and/or data derived therefrom in the classical memory 310.

The steps described above may be repeated any number of times, with what is described above as the final state of the qubits 104 serving as the initial state of the next iteration. In this way, the classical computer 304 and the quantum computer 102 may cooperate as co-processors to perform joint computations as a single computer system.

Although certain functions may be described herein as being performed by a classical computer and other functions may be described herein as being performed by a quantum computer, these are merely examples and do not constitute limitations of the present invention. A subset of the functions which are disclosed herein as being performed by a quantum computer may instead be performed by a classical computer. For example, a classical computer may execute functionality for emulating a quantum computer and provide a subset of the functionality described herein, albeit with functionality limited by the exponential scaling of the simulation. Functions which are disclosed herein as being performed by a classical computer may instead be performed by a quantum computer.

The techniques described above may be implemented, for example, in hardware, in one or more computer programs tangibly stored on one or more computer-readable media, firmware, or any combination thereof, such as solely on a quantum computer, solely on a classical computer, or on a hybrid quantum classical (HQC) computer. The techniques disclosed herein may, for example, be implemented solely on a classical computer, in which the classical computer emulates the quantum computer functions disclosed herein.

Any reference herein to the state |0> may alternatively refer to the state |1>, and vice versa. In other words, any role described herein for the states |0> and |1> may be reversed within embodiments of the present invention. More generally, any computational basis state disclosed herein may be replaced with any suitable reference state within embodiments of the present invention.

The techniques described above may be implemented in one or more computer programs executing on (or executable by) a programmable computer (such as a classical computer, a quantum computer, or an HQC) including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention update a quantum state of a physical system maintained by an agent. Such a function is inherently rooted in quantum computing technology and cannot be performed mentally or manually.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

In embodiments in which a classical computing component executes a computer program providing any subset of the functionality within the scope of the claims below, the computer program may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor, which may be either a classical processor or a quantum processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A classical computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium (such as a classical computer-readable medium, a quantum computer-readable medium, or an HQC computer-readable medium). Embodiments of the invention may store such data in such data structure(s) and read such data from such data structure(s).

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

1. A method, performed on a hybrid quantum-classical computer system, for training a quantum-enhanced learning agent,
the hybrid quantum-classical computer system comprising a classical computer and a quantum computer,
the classical computer including a processor, a non-transitory computer readable medium, and computer instructions stored in the non-transitory computer readable medium;
the quantum computer including a quantum component having a plurality of qubits encoded in quantum states of a physical system;
the quantum-enhanced learning agent having an initial state S₁, an input X₁, and a set of quantum gates with a set of parameters T₁, wherein the initial state S₁ is encoded in one or more of the plurality of qubits;
wherein the computer instructions, when executed by the processor, perform the method, the method comprising:
generating an output Y₁ by applying the set of quantum gates with the set of parameters T₁ to the initial state S₁ and input X₁,
computing a reward value R₁ based on the output Y₁;
updating the quantum-enhanced learning agent based on the reward value R₁, the updating comprising:
replacing the set of parameters T₁ with an updated set of parameters T₂; and
replacing the initial state S₁ with an updated state S₂.

2. The method of claim 1, wherein updating the quantum-enhanced learning agent comprises updating the quantum-enhanced learning agent a plurality of times, the k^{th} update having input Xₖ, an updated state Sₖ, an updated set of parameters Tₖ, and output Yₖ.

3. The method of claim 2, wherein an agent state Sᵢ is entangled with an output Yₖ output of another state Sₖ for some i≠k.

4. The method of claim 2, wherein an output Y is entangled with Sᵢ or another output Yₖ for some i≠k.

5. The method of claim 2, further comprising unrolling the quantum-enhanced learning agent in time, wherein a plurality of copies of the quantum-enhanced learning agent are simultaneously maintained, with each copy corresponding to an update of the quantum-enhanced learning agent.

6. The method of claim 5, further including generating quantum correlations by entangling states of the multiple copies of the quantum-enhanced learning agent.

7. The method of claim 6, wherein for n iterations unrolled, the method is applied to restricted quantum states such as n-qubit stabilizer states.

8. The method of claim 5, wherein the unrolling is accomplished with quantum circuits.

9. The method of claim 1, further comprising using the quantum-enhanced learning agent to solve an optimization problem by constructing a solution that optimizes an objective function having discrete steps.

10. The method of claim 9, wherein solving the optimization problem comprises evaluating each step leading to a solution by measuring designated output bits.

11. The method of claim 9, wherein the solution is evaluated at the end of each iteration.

12. The method of claim 1, further comprising using the quantum-enhanced learning agent to solve a combinatorial optimization problem.

13. The method of claim 9, wherein using the quantum-enhanced learning agent to solve the optimization problem comprises using the quantum-enhanced learning agent to produce a sequence of outputs as a destination node on a graph, comprising building the solution one component at a time.

14. The method of claim 1, further comprising using the quantum-enhanced learning agent for timeseries analysis and forecasting.

15. The method of claim 1, further comprising using the quantum-enhanced learning agent for reinforcement learning, wherein the quantum-enhanced learning agent produces a sequence of outputs for each output Y associated with the action of the quantum-enhanced learning agent.

16. The method of claim 1, further comprising using the quantum-enhanced learning agent for natural language processing NLP, wherein the quantum-enhanced learning agent receives a series of inputs based on words and produces a sequence of outputs, wherein each output is associated with an embedding.

17. The method of claim 1, further comprising using the quantum-enhanced learning agent to solve a traveling salesperson problem.

18. The method of claim 9, wherein the optimization problem comprises an optimization problem for optimum placement of chip components on a substrate.

19. The method of claim 18, wherein using the quantum-enhanced learning agent to solve the optimization problem comprises using the quantum-enhanced learning agent to build a chip placement optimization solution one step at a time.

20. A hybrid quantum-classical computer system for training a quantum-enhanced learning agent, the hybrid quantum-classical computer system comprising:
a classical computer comprising a processor, a non-transitory computer readable medium, and computer instructions stored in the non-transitory computer readable medium;
a quantum computer comprising a quantum component having a plurality of qubits encoded in quantum states of a physical system;
the quantum-enhanced learning agent having an initial state S₁, an input X₁, and a set of quantum gates with a set of parameters T₁, wherein the initial state S₁ is encoded in one or more of the plurality of qubits;
wherein the computer program instructions, when executed by the processor, are adapted to cause the processor to perform a method, the method comprising:
generating an output Y₁ by applying the set of quantum gates with the set of parameters T₁ to the initial state S₁ and input X₁,
computing a reward value R₁ based on the output Y₁;
updating the quantum-enhanced learning agent based on the reward value R₁, the updating comprising:
replacing the set of parameters T₁ with an updated set of parameters T₂; and
replacing the initial state S₁ with an updated state S₂.
